(19) United States
(12) Patent Application Publication
(10) Pub. No.: US 2014/0245167 A1
(43) Pub. Date: Aug. 28, 2014

(54) Providing Content Monitoring Information to User Devices

(71) Applicant: RHAPSODY INTERNATIONAL INC., Seattle, WA (US)

(72) Inventors: Brian Ringer, Seattle, WA (US); Heng Cao, Seattle, WA (US); Nathan Rozendaal, Tacoma, WA (US); Christian D. Nunciato, Seattle, WA (US); Jeremiah Golden, Marysville, WA (US)

(73) Assignee: RHAPSODY INTERNATIONAL INC., Seattle, WA (US)

(21) Appl. No.: 13/776,009

(22) Filed: Feb. 25, 2013

(51) Int. Cl. G06F 17/30; G06F 3/0484

(52) U.S. Cl. CPC G06F 17/30091; G06F 3/0484
USPC 715/744; 707/736

(57) ABSTRACT

Systems and methods for providing content monitoring information to a first user device. The systems and methods may comprise receiving from the first user device an indication of a geographic area, receiving data indicating content items provided to a plurality of user devices located within the geographic area, and generating a first user interface. The first user interface may comprise a map including the geographic area, and a plurality of markers on the map. Each of the plurality of markers on the map may be at a position on the map corresponding to a geographic location within the geographic area. Further, each marker may correspond to a provision of at least one of the content items provided to at least one of the plurality of user devices positioned at the geographic location corresponding to the marker.

### BACKGROUND

This application generally relates to providing content monitoring information to user devices.

A proliferation of content provider services gives users access to all types of digital content including music, movies, books, etc. Typically, a content provider service obtains license rights to a library of digital content. A user subscribes to the content provider service to receive content items, either individually or bundled together (e.g., by genre). Users receive the content items via various different types of user devices including, for example, mobile devices, other computers, network-enabled stereo receivers, etc. Users are charged according to many different types of payment methodologies including, for example, periodic subscription charges, charges by content item, charges by unit time, etc. Traditional search engines, and similar tools, allow users to search libraries of available content to find content items for viewing, listening and/or downloading.

### DRAWINGS

### Statement Under 37 C.F.R. §1.84(a)(2)

The patent or application file contains at least one drawing executed in color. Copies of this patent or patent application publication with color drawings will be provided by the Office upon request and payment of the necessary fee.

Various example embodiments are described herein by way of example in conjunction with the following figures, wherein:

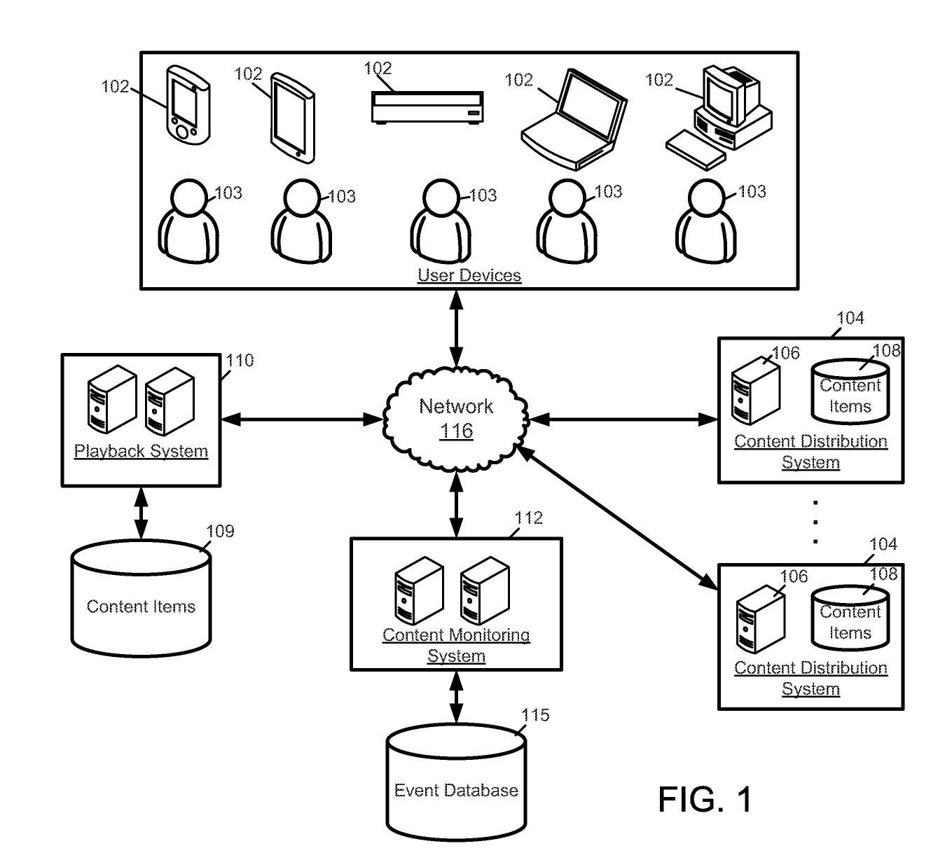

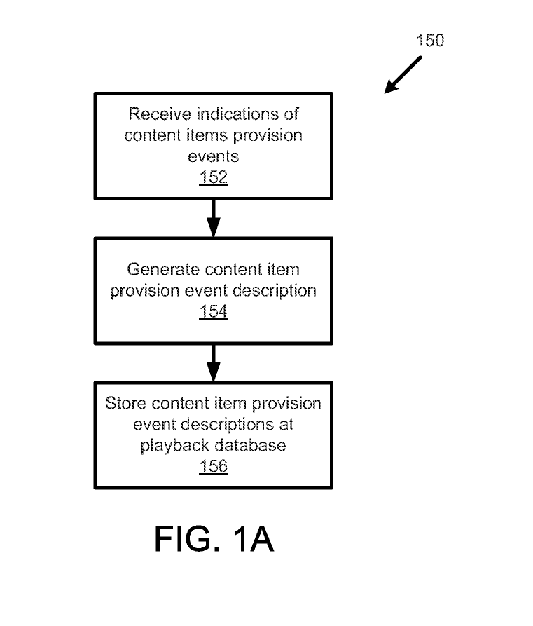

FIG. 1 is a block diagram showing one example embodiment of an environment for implementing systems and methods for providing user devices with geographic information relating to content items.

FIG. 1A is a flowchart illustrating one embodiment of a process flow that may be implemented by the content monitoring system of FIG. 1 to build an event database.

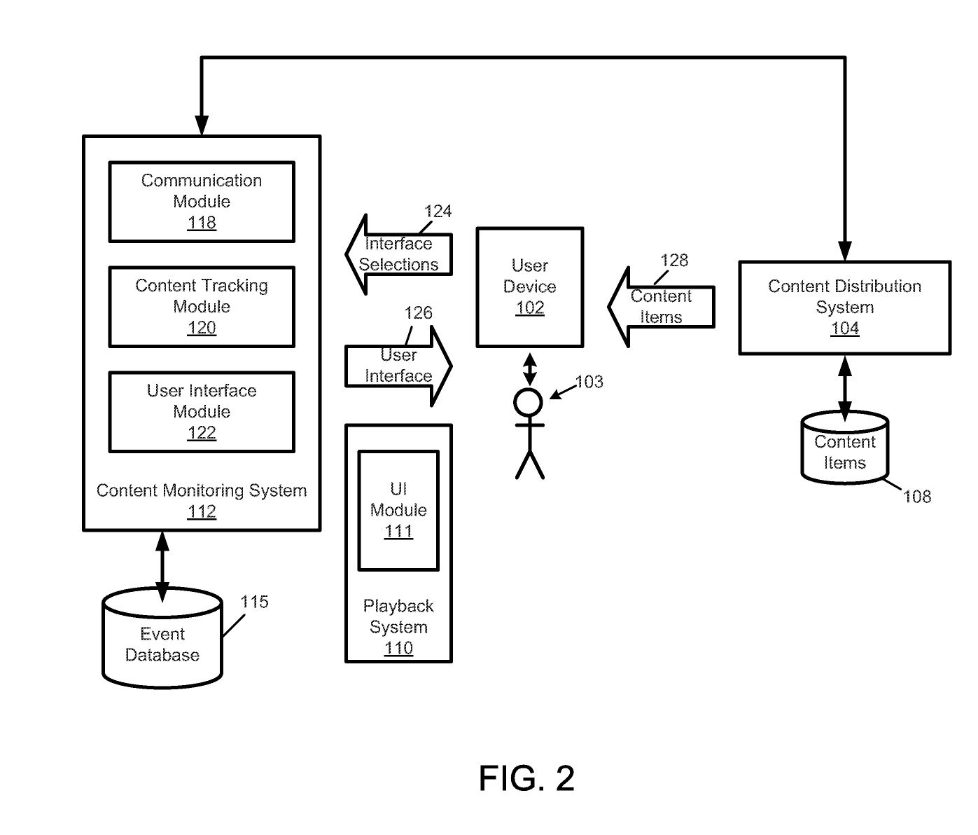

FIG. 2 is a block diagram showing one example embodiment of a content monitoring system in communication with a user device and a content distribution system.

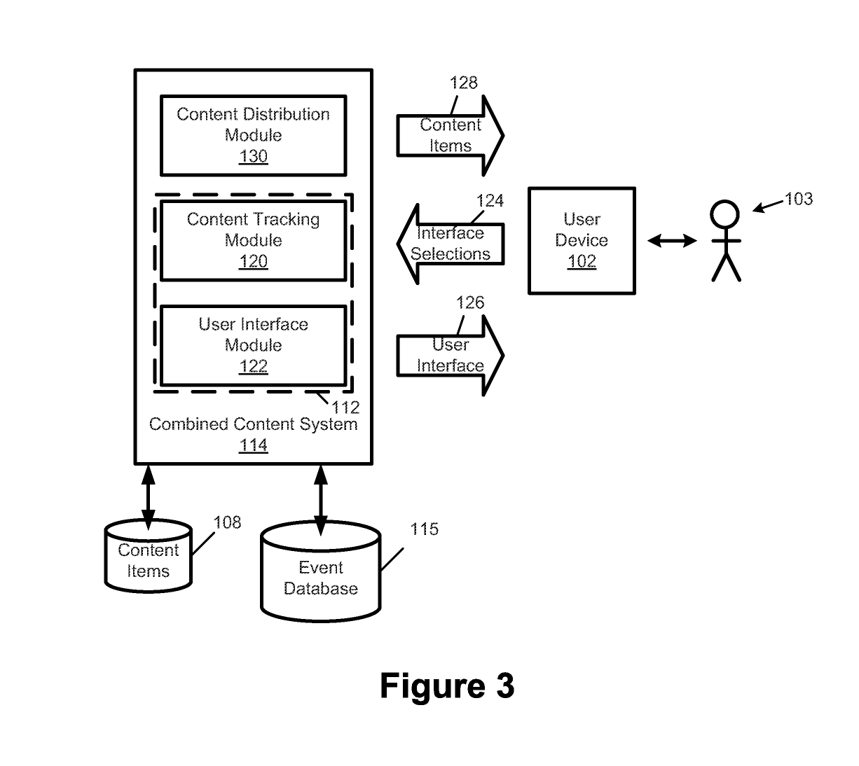

FIG. 3 is a block diagram showing another example embodiment of a content monitoring system implemented as part of a combined content system.

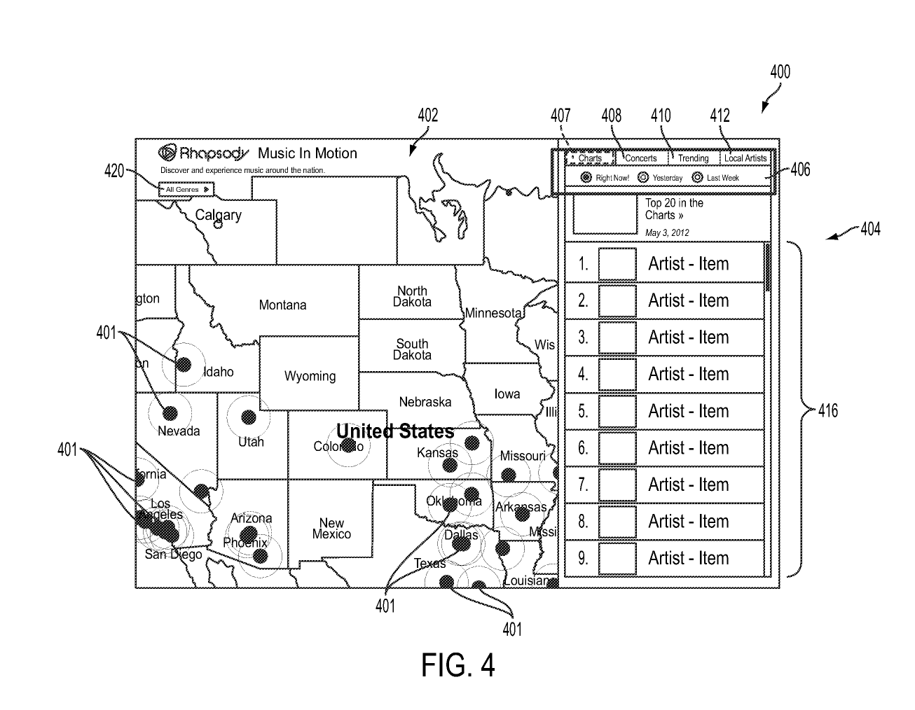

FIG. 4 is a screen shot showing one example embodiment of a screen 400 of the user interface.

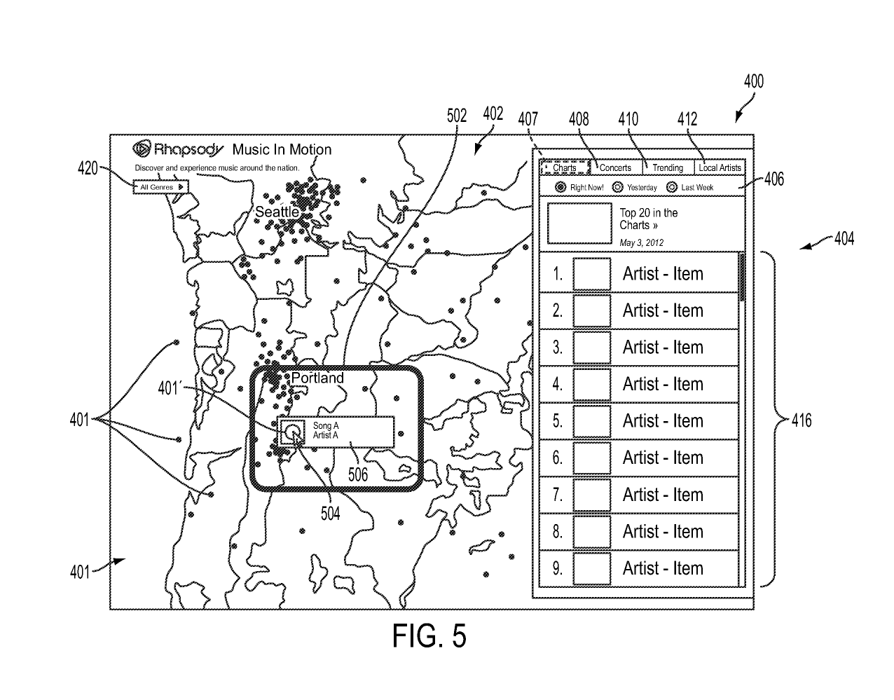

FIG. 5 is a screen shot showing one example embodiment of the screen of FIG. 4 where the user has selected a marker.

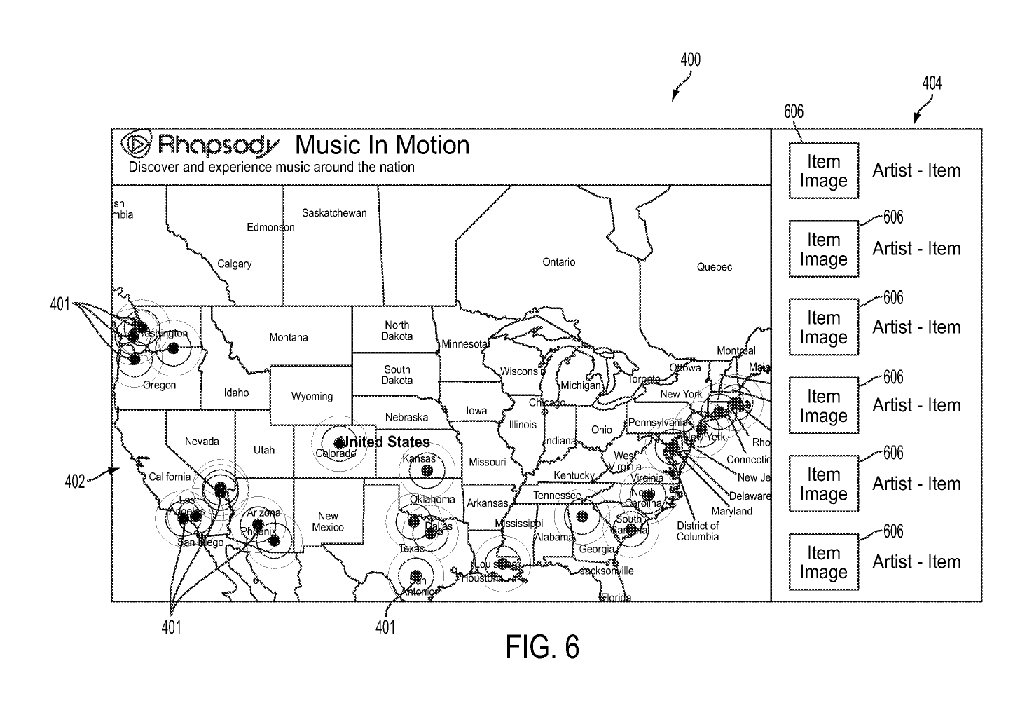

FIG. 6 is a screen shot showing one example embodiment of the screen of FIG. 4 with the information field configured to show a list of trending content items.

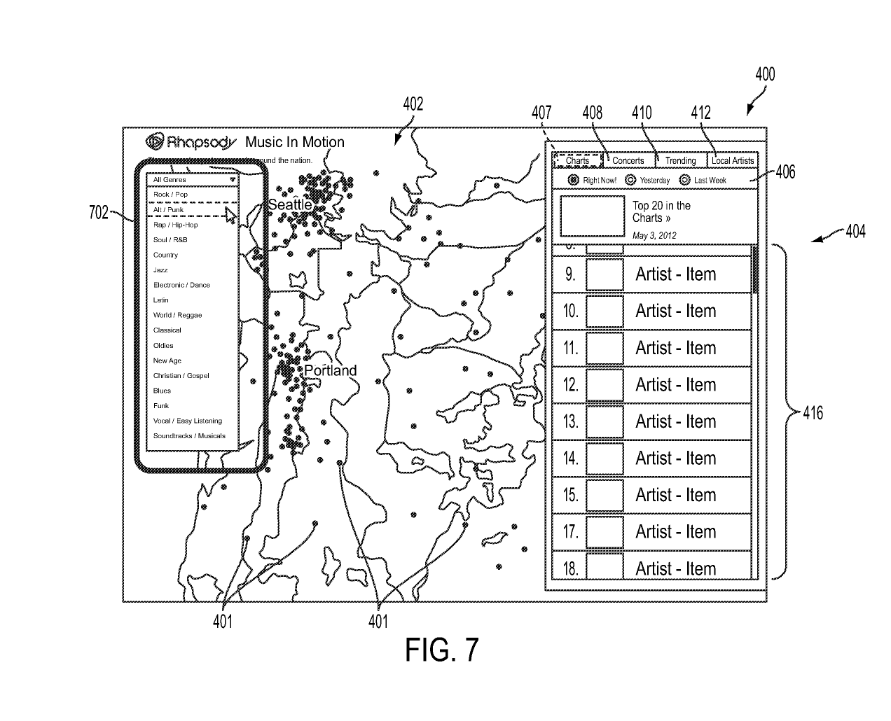

FIG. 7 is a screen shot showing one example embodiment of the screen configured to implement a content item filter.

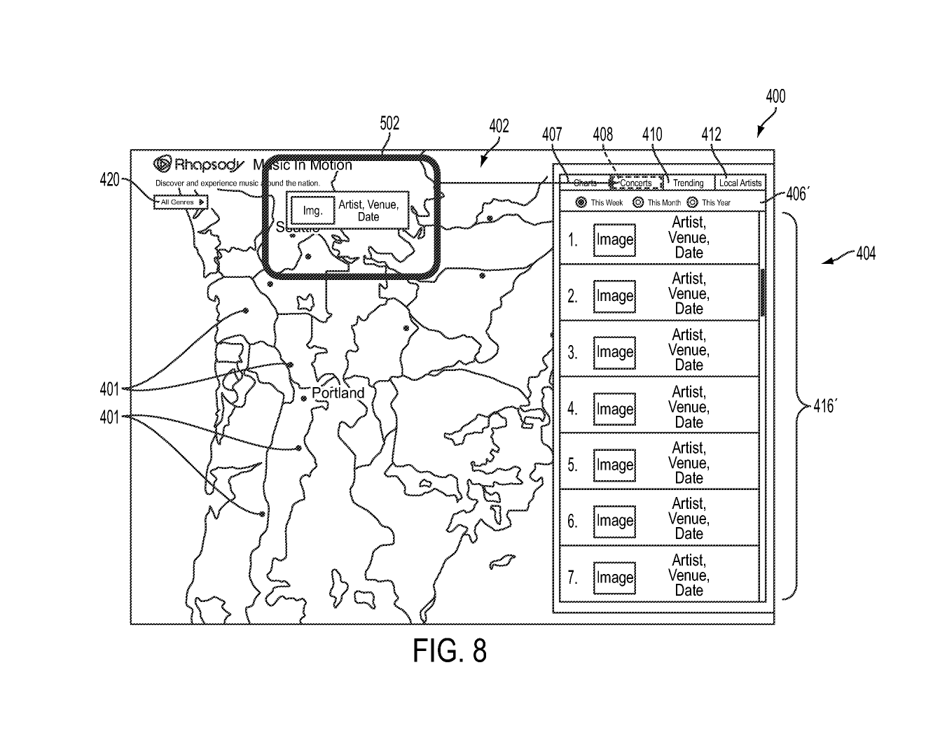

FIG. 8 is a screen shot showing one example embodiment of the screen of FIG. 4 configured to display geographic information describing events.

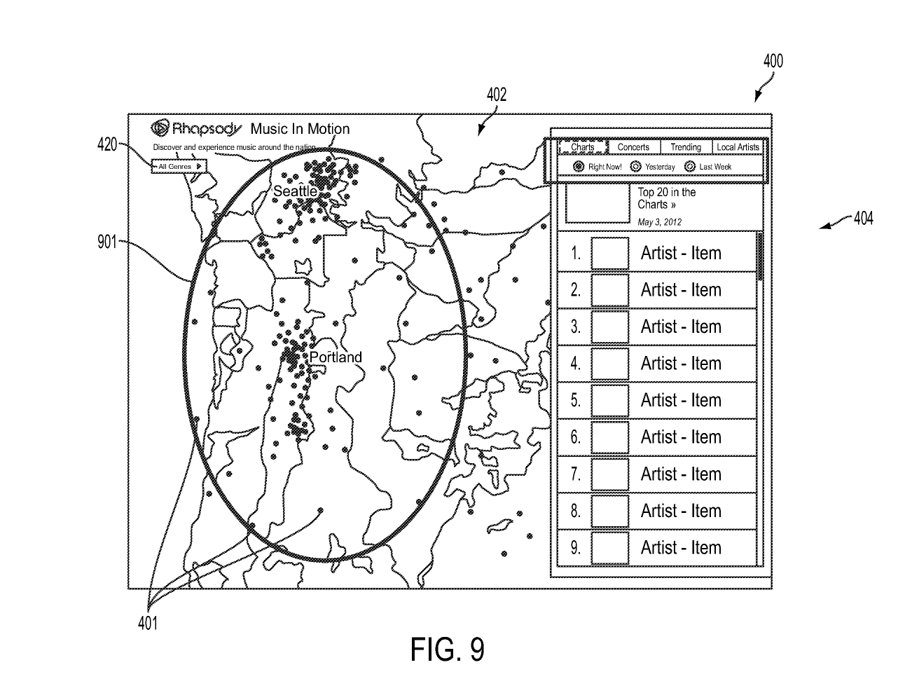

FIG. 9 is a screen shot showing one example embodiment of the screen of FIG. 4 configured to select a sub-map area.

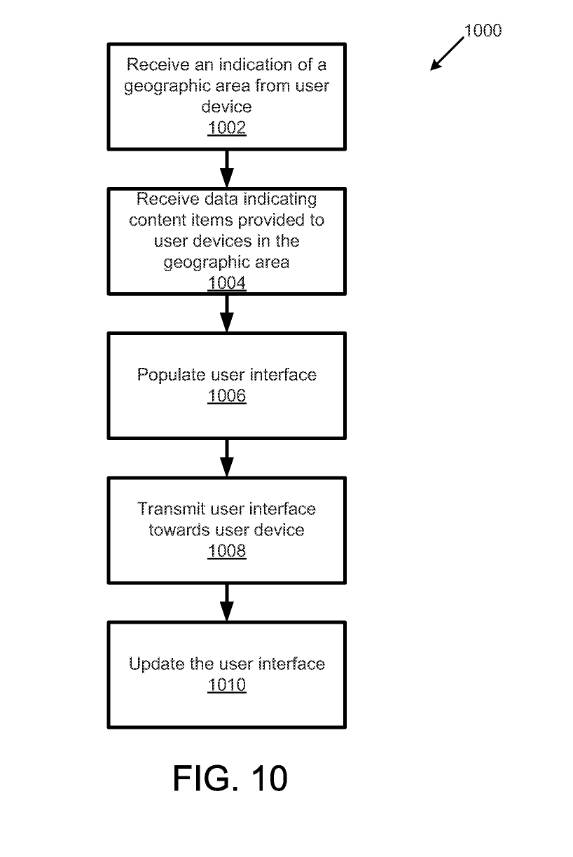

FIG. 10 is a flow chart showing one example embodiment of a process flow to generate a user interface, such as the interface screen of FIG. 4.

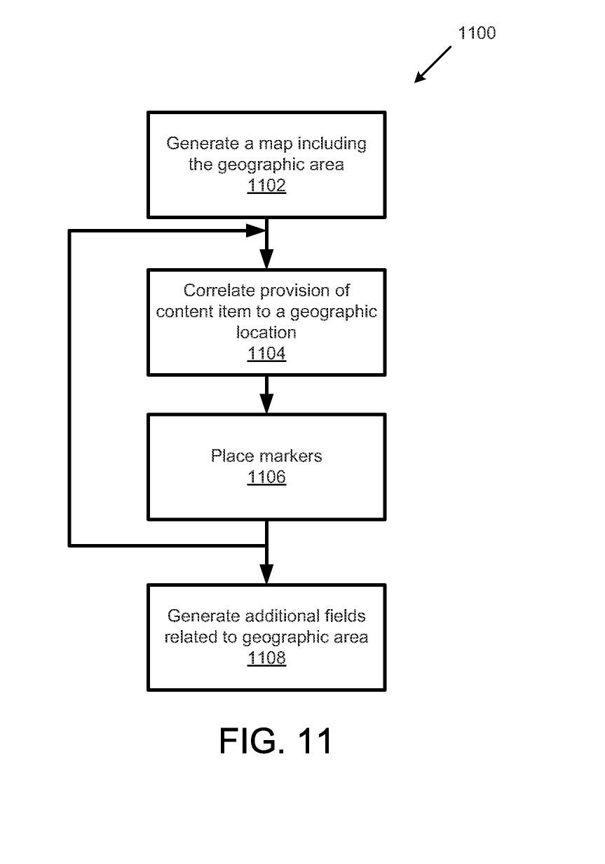

FIG. 11 is a flow chart showing one example embodiment of a process flow to populate the interface described herein with geographic information relating to content items.

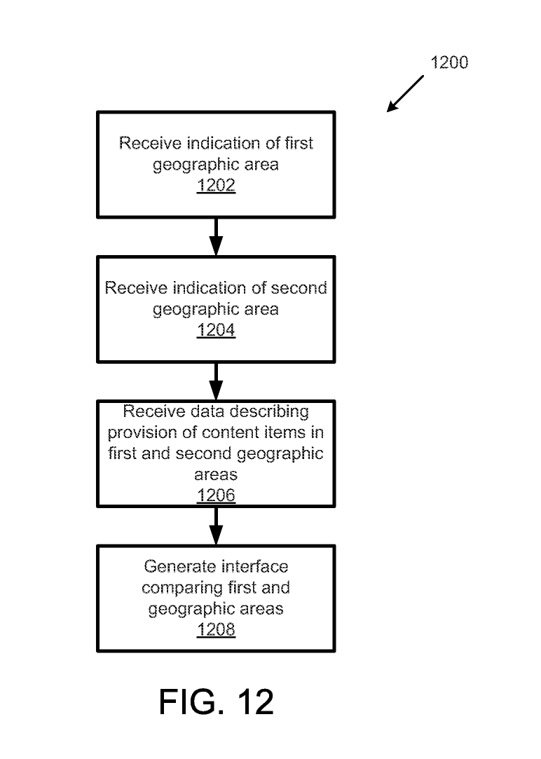

FIG. 12 is a flow chart showing one example embodiment of a process flow to compare content item events in two geographic areas.

### DESCRIPTION

Various example embodiments described herein are directed to systems and methods for providing users with geographic information relating to content items. The geographic information is conveyed to the users via a graphical user interface that may be generated and served to user devices associated with the users. In various example embodiments, the graphical user interface is generated by or in conjunction with, a content provider service for distributing content items (e.g., digital content items) to users. The content items may include any type of content (e.g., digital content) that may be provided to user devices. For example, the content items may include audio, video, and/or text files embodying any type of programming including, for example, songs, videos of any sort, books, periodicals, etc. The content provider service may implement a playback system for facilitating user interactions with content items. The playback system may provide users with functionality for identifying desirable content items. For example, the playback system may provide the users with various search engines, filters, pre-compiled play lists, etc. Through the playback system, users may select content items with which to interact. If the user selects a content item for playback or download, the playback system may cause the content item to be streamed to and or downloaded to a user device associated with the user. The playback system may cause such streaming or download to originate from a single source and/or from a content distribution network comprising multiple distributed systems.

A content monitoring system may monitor content items provided to users and generate an event database describing content item events. Content item events may describe any type of interaction between a user and a content item. Example content item events occur when a user plays a content item (e.g., the content item is streamed to the user), when the user downloads a content item, when the user likes or otherwise references a content item (e.g., via the playback system or a social media platform), etc. The content monitoring system may be programmed to record and store at the event database various information describing various content item events. Such information may include, for example, an identity of an associated user, a time of the event, a geographic location of the user (or associated user device) at the time of the event, a type of the user device, an event type (e.g., playback, download, reference, etc.).

The event database may be utilized in the graphical user interface to provide users with data describing content item events involving other users. The graphical user interface is described herein as being generated by the playback system, for example, as a portion of a general user interface for allowing users to select content items and/or by the content monitoring system. In practice, the graphical user interface may be wholly or partially implemented by any other manner and wholly or partially by any other suitable system.

In some embodiments, the user provides an indication of a geographic area (e.g., an area of interest or an area corresponding to the user's current location). In response, the graphical user interface is updated to indicate content item events within the indicated geographic area. The displayed content item events may have any suitable temporal relationship. For example, the displayed content item events may include content item events that are currently occurring (e.g., real-time events). Also, in some embodiments, the displayed content item events comprise events that have previously occurred over a determined time period (e.g., over the past day, over the past month, two years ago, etc.).

In some example embodiments, the graphical user interface comprises a map showing the selected geographic area. The map is populated with markers, where each marker corresponds to a content item event. The position of a marker on the map corresponds to a geographic location of the content item event. In some example embodiments, a user can select a marker from the user interface. In response, the interface may display additional information about the content items and/or user devices associated with the marker. In some example embodiments, the content item associated with the selected content item event is transmitted to the user (e.g., for playback or download).

In some example embodiments the graphical user interface can comprise one or more fields displaying additional information about content items provided to users in the geographic area. The additional fields may include, for example, indications of content items recently requested by users in the geographic area, indications of popular or trending content items within the geographic area over a given time period, etc. In some example embodiments, the user interface shows a comparison of two geographic areas. For example, the user interface may comprise a comparison of content item events occurring in the first and second geographic areas.

In some example embodiments, the user interface may comprise content item events selected based on a party associated with the various content items (e.g., a related party). A related party may be any individual or group associated with one or more content items. For example, related parties with respect to music content items may include an artist or band that performs a song, an author of the song, etc. Related parties with respect to a movie or video content item may include any actors or actresses that appear in the content item, a producer of the content item, a director of the content item, etc. In some example embodiments, the user provides an indication of a related party. In response, the playback system may determine a geographic area based on the locations of user events involving content items associated with the related party. For example, the locations of the users may be determined based on the locations of the users' associated user devices at the time of the events. The playback system may further generate and/or update an interface to comprise a map of the geographic area with markers positioned on the map at positions corresponding to geographic locations of the content events.

Reference will now be made in detail to several example embodiments, examples of which are illustrated in the accompanying figures. Wherever practicable, similar or like reference numbers may be used in the figures and may indicate similar or like functionality. The figures depict example embodiments of the disclosed systems (or methods) for purposes of illustration only. One skilled in the art will readily recognize from the following description that alternative example embodiments of the structures and methods illustrated herein may be employed without departing from the principles described herein.

FIG. 1 is a block diagram showing one example embodiment of an environment 100 for implementing systems and methods for providing user devices with geographic information relating to content items. The environment 100 comprises one or more playback systems 110, one or more content monitoring systems 112, one or more content distribution systems 104, and a plurality of user devices 102. Each user device 102 may be associated with a user 103. For example, a user 103 may own, lease, or otherwise have rights to use his or her associated user device 102. The user devices 102 may receive various content items and/or user interfaces from and/or through other systems 104, 110, 112 of the environment 100 and provide the content items to the associated user 103, for example, as described herein. User devices 102 may comprise any type of network-enabled computer device that may be utilized by a user to receive and/or view content items. Examples of user devices include smart phones, tablet computers, laptop computers, desktop computers, network-enabled stereo receivers, etc. In some example embodiments, each user 103 is associated with a subscription account to one or more content provider services. It will be appreciated, however, that subscription accounts may be associated with user devices 102 in addition or instead of being associated with users 103.

Content provider services may be embodied by one or more playback systems 110, which may operate in conjunction with one or more content distribution systems 104. The playback system 110 may receive a request for a content item from a user 103 (e.g., via a user interface). In response to such a request, the playback system 110 may authenticate the user 103 and/or associated user device 102 to determine that the user 103 and/or the user device 102 has an active subscription that entitles the user 103 (and/or device 102) to access the requested content item. Provided that the authentication is successful, the playback system 110 may cause the requested content item to be provided to a user device 102 associated with the requesting user 103. For example, the playback system 110 may request that the content item be transmitted to the user device 102 by a content distribution system 104. Content items may be transmitted from a content distribution system 104 to a user device 102 in any suitable manner. For example, the content items may be transmitted via a secure communication channel formed between the content distribution system 104 and the user device 102 such as a transport layer security (TLS) or secure socket layer (SSL) channel. Also, for example, some content items may be individually encrypted during communication or transmitted in the clear. It will also be appreciated that content items may be provided to user devices 102 as discrete files or units or as part of a stream of content.

The playback system 110 may be programmed to implement various tools allowing users 103 to search available content items provided via a user interface. Examples of such tools may include search engines, play lists and radio stations. Search engines allow users 103 to locate content items according to any suitable searching methodology such as, for example, key word searches, searches by genre, searches by content item type, etc. Play lists may be lists of content items, for example, stored at playback systems 110. A play list may be created automatically, created by editorial staff of the content service provider and/or created based on input from a user device 102. Play lists may be available to all users 103, only to originating users 103, to select users 103, etc. A radio station may comprise a flow of content items generated, for example, by a playback system 110 and, for example, streamed to one or more users. The content items making up a radio station flow may be repeated and/or continuously updated (e.g., by the playback system 110). Specific content items may be included in a radio station flow or may be selected based on one or more common characteristics (e.g., similarity to a set of user selected content items, a common genre, a common artist, a common theme, etc.). In some embodiments, the playback system 110 comprises a data store 109 that includes some or all of the content items that may be provided to users 103. For example, in some embodiments, the playback system 110 partially or completely provides the content items directly to the users 103 thus replacing some or all of the functionality of the content distribution systems 104.

Some content provider services may also comprise one or more content monitoring systems 112. A content monitoring system 112 may be programmed to generate an event database 115 describing content item events, as described herein. The content distribution systems 104 may comprise one or more data stores 108 comprising content items and a server or other computer device 106 for processing requests. In various example embodiments, the playback system 110 may utilize multiple distributed content distribution systems 104 as shown. Some or all of the content distribution systems 104 may be mirrors of one another located at disparate geographic and/or network locations. For example, the playback system 110 may balance the loads of various content distribution systems 104 by directing requests to transmit content items to different content distribution systems 104 based on geographic and/or network proximity between the requesting user device 102 and the various content distribution systems 104, loads on the content distribution systems 104, etc. In some embodiments, the content distribution systems 104 may be operated by a third-party vendor of the content provider service.

The various components 102, 104, 110, 112, etc. of the environment 100 may communicate with one another via a network 116. The network 116 may be any suitable type of wired, wireless, or mixed network and may comprise, for example, the Internet, a local area network (LAN), a wide area network (WAN), etc. In some example embodiments, some or all of the functionality for implementing a content provider service may be consolidated in a single system. For example, any combination of the playback system 104, the content monitoring system 112 and/or the various content distribution systems 104 may be consolidated into one or more single systems (e.g., at a common geographic location).

FIG. 1A is a flowchart illustrating one embodiment of a process flow 150 that may be implemented by the content monitoring system 112 to build the event database 115. At 152, the content monitoring system 112 may receive indications of content item events. The indications may be received from various systems. For example, in some embodiments, the content monitoring system 112 is in communication with the playback system 110. Various content item events may be initiated through the playback system 110. As described above, the user 103 may request a content item (e.g., by streaming or download) via the playback system 110. In some embodiments, the user 103 may also reference a content item though the playback system 110 (e.g., via a user interface of the playback system 110). For example, the user 103 may like or otherwise indicate approval or disapproval of the content item. The playback system 110 may provide the content monitoring system 112 with indications of content item events that it facilitates. In some embodiments, the content monitoring system 112 receives indications of content events from other systems such as, for example, one or more content distribution systems 104, outside systems (not shown in FIG. 1), etc. For example, one or more of the content distribution systems 104 may be programmed to contact the content monitoring system 112 upon the commencement of the download or streaming of a content item to a user 103. Also, for example, the content monitoring system 112 may be programmed to receive content item events from outside systems. For example, when a user 103 references a content item on a social media platform, the social media platform may provide the content monitoring system 112 with an indication of the resulting content item event. Examples of suitable social media platforms may include FACEBOOK, TWITTER, etc. Also, in some embodiments, when a user 103 references a content item on a third-party web site, the third-party web site may provide the content monitoring system 112 with an indication of the resulting content event.

At 154, the content monitoring system 112 may generate descriptions for received content item events. The descriptions may comprise detail as rich as is available. For example, in some embodiments, content item event descriptions may indicate some or all of: an identity of the user 103 associated with the content item event; a time at which the content item event occurred; a geographic location of the user 103 (or associated user device 102) during the content item event (e.g., at the time of the content item event); a description or type of the associated user device 102; a description or type of the event (e.g., playback, download, reference), etc. The geographic location of the user 103 may be determined in any suitable manner. For example, the user's associated user device 102 may comprise an on-board global positioning system (GPS) or other suitable mechanism for determining is location. When a user 103 request initiates a content item event, the associated user device 102 may report the location of the user device 102 (and the user 103) to the content distribution system 104, the playback system 110 and/or the content monitoring system 112. Also, in some example embodiments, the content monitoring system 112 derives the geographic location of a receiving user 103 based on the identity of the content distribution system 104. For example, user devices 102 being served by a content distribution system 104 in a certain geographic location may be assumed to be at the same geographic location. At 156, the content monitoring system 112 may store the generated descriptions of content item events at the event database 115.

FIG. 2 is a block diagram showing one example embodiment of a content monitoring system 112 in communication with a user device 102 and a content distribution system 104. The content distribution system 104 may provide content items 128 to the user device 102, for example, as described herein. The content monitoring system 112 comprises a communication module 118, a content tracking module 120 and a user interface module 122. The communication module 118 may be programmed to facilitate communication between the content monitoring system 112 and various other components of a content provider service such as, for example, the content distribution system 104, a playback system 110, etc.

The content tracking module 120 may be programmed to track content items events and may be programmed to build the event database 115, as described herein above with respect to FIG. 1A. The user interface module 122 may be programmed to generate a user interface 126 and provide the interface 126 to users 103 (e.g., via the associated user devices 102). The interface 126 may provide the users 103 with geographic information relating to content items, as described herein. In the course of receiving the interface 126, the users 103 may provide input 124 including, for example, certain interface selections described herein. Such input 124 may be received by the content monitoring system 112 and, in some example embodiments, may be processed and incorporated into the user interface 126 as described herein. In some embodiments, the content monitoring system 112 provides the user interface 126 directly to the end user device 102. Also, in some embodiments, the content monitoring system 112 provides the user interface 126 to the user device 102 via a user interface module 111 of the playback system 110. For example, the user interface 126 may be provided as a component of a user interface provided to the user device 102 by the playback system 110. Additionally, in some embodiments, the user interface 126 may be generated by the user interface module 111 of the playback system 110 based on data from the event database 115 queried from the content monitoring system 112.

FIG. 3 is a block diagram showing another example embodiment of a content monitoring system 112 implemented as part of a combined content system 114. According to the combined content system 114, the functionalities of the playback system 110, the content monitoring system 112 and the content distribution systems 104 are combined into a single system 114. It will be appreciated that additional combinations of the three systems 110, 112, 104 may be made. For example, the playback system 110 and the content monitoring system 112 may be consolidated, with the consolidated system continuing to utilize the content distribution systems 104. The combined content system 114, as illustrated in FIG. 3, is in communication with one or more data stores 108 comprising content items to be provided to users 103 as well as the event database 115 comprising data describing content item events, as described above. The combined content system 114 comprises a content distribution module 130 that may be programmed to provide content items 128 to users 103 in a manner similar to that of the content distribution system 104 described herein. The combined content system 114 may also comprise a content tracking module 120 and user interface module 122 similar to those described herein with respect to the content monitoring system 112.

The user interface 126 may be generated, populated, and provided to the user 103 in any suitable form. For example, FIG. 4 is a screen shot showing one example embodiment of a screen 400 of the user interface 126. The screen 400 comprises a map field 402 and at least one information field 404. The map field 402 indicates a geographic area (e.g., map area) that may be selected by the user 103 and/or by the content monitoring system 112 (e.g., as a default map area). For example, the map field 402, as configured in FIG. 4, illustrates a map area comprising the central United States. The map field 402 comprises a plurality of markers 401. Each marker 401 corresponds to at least one content item event. The markers 402 are positioned on the map field 402 at positions indicating the geographic location of the corresponding content item event. Some markers 402 correspond to a single content item event. In some example embodiments, one or more markers 402 may correspond to multiple content item events. For example, when the map area shown at the map field 402 is large and/or when more than one content item event occurs in close geographic and/or temporal proximity, a single marker 402 may correspond to more than one content item event.

The markers 401 shown at the map field 402 may be displayed according to any suitable temporal scheme. In some example embodiments, the map field 402 (and information field 404) may be populated at the time that the user 103 requests the screen 400 and may remain static until the user re-requests the screen 400 and/or requests a refresh. Also, in some example embodiments, the content monitoring system 112 may periodically refresh the interface 126, including the screen 402. For example, markers 401 may be periodically removed as they become stale. A stale marker may be a marker 401 corresponding to a content item event that has occurred more than a threshold time in the past. Also, new markers 401 may be added, for example, in real-time as the content monitoring system 112 receives new data indicating additional content item events in the map area.

In various example embodiments, the markers 401 are selectable by the user 103. When the user 103 selects a marker 401, the content monitoring system 112 may provide the user 103 with additional data describing the corresponding content item event and may, in some example embodiments, provide the user 103 with a corresponding content item. For example, FIG. 5 is a screen shot showing one example embodiment of the screen 400 of FIG. 4 where the where a user 103 has selected a marker 401′. As can be seen, the map area shown by the map field 402 in FIG. 5 is a portion of the Pacific northwest including the cities of Portland and Seattle. Also shown in FIG. 5 is a cursor 504. To select the marker 401′, the user may position the cursor 504 above the desired marker, as shown. In example embodiments where the user device 102 comprises a touch screen, the cursor 504 may be omitted. Upon selection of the marker 401′, the content monitoring system 112 may provide on the screen 500 a marker field 502. The marker field 502 may be positioned, for example, at the same point as the selected marker 401′.

The marker field 502 may comprise various information about the content item event or events associated with the selected marker 401′. Such information may include, for example, an indication of one or more content items associated with the content item event. For example, the marker field 502 comprises a content item field 506 indicating a content item associated with the content item event. In the example shown in FIG. 5, the content item field 506 indicates a song and a related party (e.g., an artist). Although the marker field 502 comprises an indication of a single content item, it may comprise indications of multiple content items (e.g., the content item field 506 may indicate more than one content item or the marker field 502 may comprise more than one content item fields 506). For example, when the selected marker 401′ corresponds to more than one content item event and/or a content item event involving more than one content item, the marker field 502 may indicate more than one marker item. In some example embodiments, the marker field 502 may comprise additional information about the associated content item event such as, for example, an identification of the user receiving the content item, a textual indication of the location of the user receiving the content item, etc.

In various example embodiments, the user 103 may select an indication of a content item from the content item field 506. In response, the content monitoring system 112 may perform various actions including, for example, providing the content item to the user 103, adding the content item to a play list associated with the user, adding a characteristic of the content item to a description of preferred content items associated with the user, etc. For example, upon receiving an indication of the user's selection of the content item from the associated user device 102, the content monitoring system 112 may communicate with the playback system 110 and/or the content distribution system 104 to cause the content distribution system 104 to provide the content item 128 to the user 103. In some example embodiments, upon receiving an indication of the user's selection, the content monitoring system 112 adds the selected content item to a play list associated with the user 103. This may allow the user 103 to access the selected content item later as a part of the play list.

Also, in some example embodiments, upon receiving an indication of the user's selection, the content monitoring system 112 may add at least one characteristic of the content item to a description of preferred content items associated with the user 103. The characteristic of the content item may be any descriptive characteristic. For example, when the content item is a song, example characteristics may include related parties, the genre, the year in which the song was originally released, etc. Also, for example, when the content item is a movie or other video programming, example characteristics may include, related parties, the year in which the movie or other video programming was originally released, etc.

The description of preferred content for the user 103 may be a set of content characteristics utilized by the content monitoring system 112, the playback system 110 or any other component of content provider service to select content items that may be of interest to the user 103. In some example embodiments, the description of preferred content may be utilized to generate a radio station flow for the user 103, for all users and/or for a selected group of users (e.g., selected by the user 103). Also, in some example embodiments, the content monitoring system 112, the playback system 110 or any other component of the content provider service may provide the user 103 with indications of suggested content items, based on the description of preferred content.

In some example embodiments, the content monitoring system 112 may be programmed to cause various markers 401 in the map field 402 to display marker fields 502 periodically without input from the user 103. For example, the content monitoring system 112 may randomly select markers 401 from the map field 402. The selected markers 401 may display marker fields 502 for a predetermined amount of time (e.g., 2 seconds). In some example embodiments, some portion or percentage of markers 401 being added to the map field 402 may be selected to temporarily display marker fields 502, for example, as they are initially displayed at the map field 402.

Referring to both FIGS. 4 and 5, the information field 404 may comprise various additional information about content items provided to users 103 in the map area shown by the map field 402. The information screen 404 comprises a series of tabs 407, 408, 410, 412 with each tab indicating a category of information to be displayed at the field 404. By selecting one of the tabs 407, 408, 410, 412 the user 103 may cause the content monitoring system 112 to populate the information field 404 with corresponding data regarding provided content items. For example, in FIG. 5, a Charts tab 407 is selected. Accordingly, the information field 404 comprises a chart content item field 416 that comprises a chart of content items. The chart may include a listing of leading content items in the map area (e.g., content items that are most frequently provided to users 103). In some embodiments, cover art or other images associated with each content item may be shown. The chart may be associated with a time period. For example, the user 103 may select a time period for the chart from a time period field 406. A Right Now time period selection may cause the chart content item field 416 to display a list of leading content items that are currently being provided to users 103 and/or that have been provided over a recent time period (e.g., in the last minute, hour, etc.). A Yesterday time period selection may cause the chart content item field 416 to display a list of leading content items provided yesterday. A Last Week time period selection may cause the chart content item field 416 to display a list of leading content items provided during the past week. Additional and/or different time period selections may be available in some example embodiments.

The additional tabs 408, 410, 412, when selected, may cause the information field 404 to display other content items. For example, a Trending tab 410 may cause the information field 404 to display indications of content items that are trending. FIG. 6 is a screen shot showing one example embodiment of the screen 400 with the information field 404 configured to show a list of trending content items 606. In some embodiments, the list of trending content items 606 includes, for each content item 606, cover art or another item image as well as the name of the item 606. The trending content items 606 may be content items that are being currently provided to users 103 in the map area. The content items 606 shown at the information field 404 may be those content items that are being currently provided to users 103 in the map area at the highest frequency. Items 606 within the field 404 may be arranged according to the frequency at which the content items are provided to user devices within the map area.

Referring now back to FIG. 4, a Local Artists tab 412, when selected by the user 103, may cause the content monitoring system 112 to populate the information field 404 with content items that are associated with local artists or other related parties. Local artists or related parties may be artists or related parties that are from the map area. In some example embodiments, local artists or related parties may be artists or related parties that are from a location within a threshold distance of a content item event. For example, the provision of a song by a Dallas-based artist to a user 103 in Ft. Worth may be considered to be associated with a local artist. In some example embodiments, selection of the Local Artists tab 412 may cause the content monitoring system 112 to implement a content item filter blocking markers 401 that are not associated with local artists or related parties.

In some example embodiments, the content monitoring system 112 may be programmed to implement functionality for applying various content item filters to the interface 126 (e.g., the screen 400). For example, FIG. 7 is a screen shot showing one example embodiment of the screen 400 configured to implement a content item filter. As illustrated in FIG. 7, the screen 400 comprises a filter field 702. The filter field 702 may be displayed, for example, when the user 103 selects a filter option from the screen 400. For example, the screen 400 may comprise a filter button 420 (FIGS. 5 and 8). Upon selection of the filter button 420 by the user 103, the content monitoring system 112 may display the filter field 702. The filter field 702 may comprise a list of content item characteristics. The user 103 may select one or more content item characteristics from the field 702. Upon the selection, the content monitoring system 112 may filter new content item events. The map field 402 and/or the information field 404 may be populated only with markers 401 and/or information describing content item events for content items that have the one or more selected content item characteristics. Example content item characteristics may include, for example, a genre of a song or movie, a related party, etc.

FIG. 8 is a screen shot showing one example embodiment of the screen 400 of FIG. 4 configured to display geographic information describing events. For example, the content monitoring system 112 may generate the screen 400 as illustrated in FIG. 8 upon selection by the user 103 of the Concerts tab 408. As shown in FIG. 8, the screen 400 is configured to display geographic information regarding public events. The public events may be related to content or content items. For example, the events may be concerts by artists that generate a portion of the content items distributed by the content provider service, public appearances by related parties to content items, etc. In some example embodiments, public events may be occurrences that the user 103 may want to attend. In FIG. 8, markers 401 in the map field 402 may correspond to public events rather than to content item events. Markers 401 may be selected by the user 103 to cause the display of a marker field 502 that may display information about the public event corresponding to the marker 401. Also, as shown in FIG. 8, the information field comprises a public event field 416′ including a list of public events in the map field 402. Public events in the public event field 416′ may be indicated by various information describing the event such as, for example, an artist, a venue a date and, in some embodiments, an image representative of the public event (e.g., an image of the artist). In some example embodiments, the public events indicated at the map field 402 and the information field 404 may be filtered based on time. For example, public events may be limited to events that will occur in the future. A time filter field 406′ may receive from the user 103 a time filter to be applied to public events shown by the screen 400. A This Week time period selection may cause the screen 400 to display public events occurring in the current week, within one week of the current date, etc. A This Month time period selection may cause the screen 400 to display public events occurring in the current month, within one month of the current date, etc. A This Year time period selection may cause the screen 400 to display public events occurring in the current year, within one year of the current date, etc.

In various example embodiments, the user 103 may select a new map area and/or limit the screen 400 to a portion of the map area. For example, FIG. 9 is a screen shot showing one example embodiment of the screen 400 of FIG. 4 configured to select a sub-map area. As illustrated in FIG. 9, the screen 400 comprises a boundary 901. The boundary 901 may be generated on the screen 400 by a user according to any suitable method. For example, the user 103 may utilize a cursor, touch-screen or similar device to draw the boundary 901 on the map field 402. In some example embodiments, the boundary 901 may be of a pre-defined shape (e.g., square, ovaloid, etc.). The user 103 may place and size the pre-defined shape to determine the boundary 901. Also, in some example embodiments, the boundary 901 may be drawn “free-hand”with the user 103 determining the contours of the boundary 901 not according to a predetermined shape. As illustrated in FIG. 9, the screen 400 may be configured to reflect content item events (and/or public events) that occur in a geographic area corresponding to the area within the boundary 901. Events occurring outside of the boundary, for example, may not figure in the populating of the information field 404. Also, in some example embodiments, the boundary 901 may indicate a new map area. For example, the content monitoring system 112 may re-generate the screen 400 with the map field 402 corresponding wholly or predominately to the geographic area within the user-selected boundary 901. In this way, the user 103 may “zoom” the screen 400 to a new map area within the pre-existing map area.

The playback system 110 and/or content monitoring system 112 may generate the various example embodiments of the interface 126 described herein in any suitable manner. For example, FIG. 10 is a flow chart showing one example embodiment of a process flow 1000 to generate a user interface, such as the interface screen 400 described herein. At 1002, the playback system 110 and/or content monitoring system 112 may receive an indication of a selected geographic area from the user 103. The indication of the geographic area may be received in any suitable manner. In some example embodiments, the user 103 provides the indication of the selected geographic area by providing an indication of a political unit such as, for example, a municipality, a state, a province, a country, a postal code, etc. Also, in various example embodiments, the user 103 may provide the indication of the selected geographic area via the user interface 126, for example, as described herein above with respect to FIG. 9. In some example embodiments, rather than receiving the indication of the selected geographic area from the user device 102, the playback system 110 and/or content monitoring content monitoring system 112 may select a default geographic area. The default geographic area may be, for example, selected based on a location of the user 103 (e.g., as reported by the user's associated user device 102). For example, the default geographic area may include a nation, state, municipality, etc., where the user 103 is located.

At 1004, the playback system 110 and/or content monitoring system 112 may receive data describing content item events in the selected geographic area. Content item events may be received from any suitable system (e.g., a playback system 110, a content distribution system 104, the event database 115, etc.) according to any suitable communication protocol or method. The received content item event data may indicate, for each content item event, a subject content item 128 or items and a location of the associated user 103. In some example embodiments, the content item event data may also comprise an identity of the user 103. Content item event data may be received from any suitable source or system including, for example, a playback system 110, a content distribution system 104, a content monitoring system 112, etc.

At 1006, the user interface 126 may be populated with indications of at least a portion of the content item events in the selected geographic area. For example, the indications of the content item events may comprise markers, such as the markers 401 and/or any of the data that may be present in the information field 404 described above. In some example embodiments, content item event data may be filtered, as described herein above with respect to FIG. 7, before populating the interface. The populated user interface may be transmitted towards the user 102 at 1008. At 1010, the user interface 126 may be updated. For example, as additional content item events occur (and the content monitoring system 112 receives content item event data describing them) the system 112 may re-populate the user interface 126. In some embodiments, the repopulation occurs in real time. For example, additional content item event data may be received and the user interface 126 may be updated to indicate the additional content item event data. Also, in some example embodiments, indications of content item events (e.g., markers 401) that are stale may be removed from the interface 126. Stale content item events may be events that occurred more than a threshold time period in the past. In some example embodiments, updating the user interface 126 also comprises updating additional fields in the interface, such as the information field 404. Updating the interface may occur periodically and/or continuously.

FIG. 11 is a flow chart showing one example embodiment of a process flow 1100 that may be executed by the playback system 110 and/or the content monitoring system 112 to populate the interface with geographic information relating to content items. For example, the screen 400 may be populated in the forms described herein. At 1102, the playback system 110 and/or content monitoring system 112 may generate a map (e.g., a graphical map) of the map area, such as the map field 402 of the screen 400 described above. The map area may be received from the user 103 and/or may be based on a default setting. At 1104, content item events may be correlated to geographic locations indicated by the map field 402. For example, content item event data may indicate a geographic location for some or all of the content item events. The geographic location for content item events may be matched to a physical location on the map field 402. At 1106, markers 401 may be placed on the map field 402. The markers 401 are positioned on the map field 402 at positions indicating the geographic location of the corresponding content item event, as described above with respect to FIG. 4. Referring back to the process flow 1100, at 1108, additional information fields, such as the field 404 described herein above, may also be populated.

In some example embodiments, the playback system 110 and/or content monitoring system 112 may also be programmed to generate a comparison of content items provided to two different geographic areas. For example, FIG. 12 is a flow chart showing one example embodiment of a process flow 1200 that to compare content item events in two geographic areas. At 1202, the playback system 110 and/or content monitoring system 112 may receive an indication of the first geographic area from a user 103. The user 103 may provide the indication of the first geographic area in any suitable manner. For example, the user 103 may provide an indication of a political unit such as, for example, a municipality, a state, a province, a country, a postal code, etc. Also, in various example embodiments, the user 103 may provide the indication of the selected geographic area via a user interface 126, for example, as described herein above with respect to FIG. 9. At 1204, the playback system 110 and/or content monitoring system 112 may receive an indication a second geographic area. At 1206, the playback system 110 and/or content monitoring system 112 may receive data describing content item events in the first and second geographic areas.

At 1208, an interface and/or interface screen comparing the first and second geographic areas may be generated. For example, the interface may comprise lists of trending content items and/or content items provided with the highest frequencies in the first and second geographic areas such as, for example, side-by-side implementations of the information field 404 described herein, with each of the side-by-side fields corresponding to one of the geographic areas. Also, for example, the interface may comprise side-by-side map fields, such as the map field 402, wherein each of the side-by-side map fields comprises markers 401 corresponding to content item events and/or public events in the respective geographic areas.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Reference in the specification to “one example embodiment,” “various example embodiments,” or to “an example embodiment” means that a particular feature, structure, or characteristic described in connection with the example embodiments is included in at least one example embodiment of the invention. The appearances of the phrase “in one example embodiment” or “a preferred example embodiment” in various places in the specification are not necessarily all referring to the same example embodiment. Reference to example embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient, at times, principally for reasons of common usage, to refer to these signals as bits, values, elements, symbols, characters, terms, numbers, or the like. Furthermore, it is also convenient, at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred example embodiment and several alternate example embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A computer-implemented system for providing content monitoring information to a first user device, the system comprising:
a computer system comprising at least one processor and operatively associated memory, wherein the computer system is programmed to:
receive from the first user device an indication of a geographic area;
receive data indicating content items provided to a plurality of user devices located within the geographic area;
generate a first user interface, the first user interface comprising:
a map including the geographic area; and
a plurality of markers on the map, wherein each of the plurality of markers is at a position on the map corresponding to a geographic location within the geographic area, and wherein each marker corresponds to a provision of at least one of the content items provided to at least one of the plurality of user devices positioned at the geographic location corresponding to the marker; and
transmit the first user interface towards the first user device.

2. The system of claim 1, wherein the computer system is further programmed to:
after generating the first user interface, update the first user interface, wherein, after the updating, the first user interface comprises a second plurality of markers on the map, wherein each of the second plurality of markers is at a position on the map corresponding to a geographic location within the geographic area, and wherein each of the second plurality of markers corresponds to a provision of at least one of the content items provided to at least one of the plurality of user devices positioned at the geographic location corresponding to the marker after the generation of the first user interface.

3. The system of claim 2, wherein the updating comprises removing at least a portion of the plurality of markers from the map.

4. The system of claim 1, wherein the computer system is further programmed to:
receive from the first user device an indication of a first marker selected from the plurality of markers; and
in response to the indication, transmit towards the first user device an indication of a first content item provided to at least one of the plurality of user devices at the geographic location corresponding to the first marker.

5. The system of claim 1, wherein the computer system is further programmed to:
receive from the first user device an indication of a first marker selected from the plurality of markers; and
in response to the indication, cause a first content item provided to at least one of the plurality of user devices at the geographic location corresponding to the first marker to be transmitted towards the first user device.

6. The system of claim 1, wherein the computer system is further programmed to:
receive from the first user device an indication of a first marker selected from the plurality of markers; and
add to a play list associated with the first user device a first content item provided to at least one of the plurality of user devices at the geographic location corresponding to the first marker.

7. The system of claim 1, wherein the computer system is further programmed to:
receive from the first user device an indication of a first marker selected from the plurality of markers; and
add to a description of preferred content items associated with the first user device at least one characteristic of a first content item provided to at least one of the plurality of user devices at the geographic location corresponding to the first marker.

8. The system of claim 1, wherein at least a portion of the plurality of markers corresponds to at least one content item provided to multiple user devices from the plurality of user devices.

9. The system of claim 1, wherein receiving from the first user device the indication of the geographic area comprises:
transmitting towards the first user device a map of a broad geographic area comprising the geographic area; and
receiving from the first user device an indication of the geographic area on the map of the broad geographic area.

10. The system of claim 1, wherein receiving from the first user device the indication of the geographic area comprises receiving an indication of a political unit corresponding to the geographic area.

11. The system of claim 1, wherein the computer system is further programmed to:
receive from the first user device a request to zoom from the geographic area to a second geographic area within the first geographic area; and
generate a second user interface, the second user interface comprising:
a second map of the second geographic area; and
a second plurality of markers on the second map, wherein each of the second plurality of markers is at a position on the second map corresponding to a geographic location within the second geographic area, and wherein each marker of the second plurality of markers corresponds to at least one of the content items provided to at least one of the plurality of user devices positioned at the geographic location corresponding to the marker.

12. The system of claim 1, wherein the first user interface further comprises a list of content items provided to the plurality of user devices located within the geographic area.

13. The system of claim 12, wherein the computer system is further programmed to update the list as additional content items are provided within the geographic area.

14. The system of claim 12, wherein the computer system is further programmed to:
receive from the first user device an indication of a second content item selected from the list of content items; and
perform at least one action selected from the group consisting of: transmitting towards the first user device data describing the second content item; and causing the second content item to be transmitted towards the first user device.

15. The system of claim 1, wherein the computer system is further programmed to apply a content item filter to the data indicating content items provided to the plurality of user devices located within the geographic area during the first time period such that all of the plurality of markers correspond to the provision of content items having a common characteristic.

16. The system of claim 1, wherein the first interface further comprises a field showing indications of content items arranged based on the frequency at which the content items were provided to the plurality of user devices located within the geographic area.

17. The system of claim 1, wherein the first user interface further comprises:
an indication of content items provided to the first plurality of user devices located within the geographic area; and
an indication of content items provided to a second plurality of user devices located within a second geographic area.

18. The system of claim 1, wherein the computer system is further programmed to:
receive from the first user device an indication of a content item related party;
determine a second geographic area based on locations of user devices from the plurality of user devices provided with content items associated with the related party, and wherein the first user interface further comprises:
a second map of the second geographic area; and
a second plurality of markers on the second map, wherein each of the second plurality of markers is at a position on the map corresponding to a geographic location within the geographic area, and wherein each of the second plurality of markers corresponds to at least one of the content items associated with the related party and provided to at least one of the plurality of user devices positioned at the geographic location corresponding to the marker.

19. A computer-implemented method for providing content monitoring information to a first user device, the method comprising:
receiving, by a computer system, from the first user device an indication of a geographic area, wherein the computer system comprises at least one processor and operatively associated memory;
receiving, by the computer system, data indicating content items provided to a plurality of user devices located within the geographic area;
generating, by the computer system, a first user interface, the first user interface comprising:
a map including the geographic area; and
a plurality of markers on the map, wherein each of the plurality of markers is at a position on the map corresponding to a geographic location within the geographic area, and wherein each marker corresponds to a provision of at least one of the content items provided to at least one of the plurality of user devices positioned at the geographic location corresponding to the marker; and
transmitting, by the computer system, the first user interface towards the first user device.

20. A computer-implemented system for gathering content event data, the system comprising:
a computer system comprising at least one processor and operatively associated memory, wherein the computer system is programmed to:
receive data describing a plurality of content item events, wherein the data describes, for each content item event, a content item associated with the content item event and a user associated with the content item event;
generate a description for each of the plurality of content item events, wherein each of the plurality of descriptions indicates the content item associated with the content item event, the user associated with the content item event, and a location of the user associated with the content item event; and
store the descriptions for each of the plurality of content item events at a data storage.

21. The system of claim 20, wherein the data describing the plurality of content item events also describes, for at least a portion of the content item events, the location of the user associated with the content item event.

22. The system of claim 20, wherein the computer system is further programmed to, for at least a portion of the content item events, derive the location of the user associated with the content item event.

23. The system of claim 22, wherein deriving the location of the user associated with the content item event comprises querying a user device associated with the user.

24. The system of claim 22, wherein deriving the location of the user associated with the content item comprises determining a geographic location of a content distribution system associated with the content item event.

25. The system of claim 20, wherein at least a portion of the data describing the plurality of content item events is received from a third party system.

26. The system of claim 20, wherein each of the content item events describes at least one event selected from the group consisting of: a provisioning of a content item to a user; and a reference to a content item made by the user.

27. The system of claim 20, wherein the data describing the plurality of content item events also describes, for each content item event, a time of the content item event.

28. The system of claim 20, wherein the description for each of the plurality of content item events also comprises, for each content item event, a time of the content item event.

29. A computer-implemented method for gathering content event data, the method comprising:
receiving, by a computer system, data describing a plurality of content item events, wherein the data describes, for each content item event, a content item associated with the content item event and a user associated with the content item event, wherein the computer system comprises at least one processor and operatively associated memory;
generating, by the computer system, a description for each of the plurality of content item events, wherein each of the plurality of descriptions indicates the content item associated with the content item event, the user associated with the content item event, and a location of the user associated with the content item event; and
storing, by the computer system, the descriptions for each of the plurality of content item events at a data storage.
